(19) United States
(12) Patent Application Publication
(10) Pub. No.: US 2021/0291868 A1
(43) Pub. Date: Sep. 23, 2021

(54) Travel Control Device and Travel Control Method

(71) Applicant: Hitachi Automotive Systems, Ltd., Hitachinaka-shi, Ibaraki (JP)

(72) Inventors: Yuuki OKUDA, Tokyo (JP); Takashi OKADA, Tokyo (JP)

(21) Appl. No.: 17/262,028

(22) PCT Filed: Jul. 29, 2019
(86) PCT No.: PCT/JP2019/029568

§ 371 Date: Jan. 21, 2021

(30) Foreign Application Priority Data
Aug. 28, 2018 (JP) 2018-159460

(51) Int. Cl. B60W 60/00; G06K 9/00; G06K 9/62; B60W 30/18; B60W 40/107

(52) U.S. Cl. CPC B60W 60/0023; B60W 60/0015; G06K 9/00825; G06K 9/6267; G06K 2209/15; B60W 40/107; B60W 2554/4023; B60W 2554/80; B60W 2554/404; B60W 30/18163

(57) ABSTRACT

The present invention makes it possible to achieve both securing safety and energy saving at the time of following a preceding vehicle. In the present invention, the preceding vehicle feature amount extraction unit 101 extracts the feature amounts of the preceding vehicle based on the information transmitted from the outside world recognition unit 120, the own vehicle information recognition unit 130, the communication unit 140, and the information storage unit 150, the preceding vehicle classification unit 102 classifies the preceding vehicle based on the feature amount of the preceding vehicle obtained from the preceding vehicle feature amount extraction unit 101, and the travel planning unit 103 corrects the inter-vehicle distance or inter-vehicle time at the time of following the preceding vehicle, or proposes a lane change to an adjacent lane based on the classification result of the preceding vehicle classification unit 102.

### TECHNICAL FIELD

The present invention relates to a travel control device and a travel control method for a vehicle.

### BACKGROUND ART

Conventionally, as techniques related to vehicle travel control, for example, there are techniques described in PTLs 1 and 2. PTL 1 discloses a follow-up travel device provided with a correction unit that detects the acceleration of the preceding vehicle, and corrects the target inter-vehicle distance to a larger value when the preceding vehicle can generate larger acceleration than the own vehicle. According to the control device of this vehicle, the vehicle is said to be able to cope with even the sudden braking of the preceding vehicle, without impairing the follow-up performance, to stop.

PTL 2 discloses a vehicle travel control device that adjusts a control amount during follow-up travel based on shape data on a preceding vehicle. According to the travel control device for this vehicle, it is said that adjusting the control amount during follow-up travel makes it possible to avoid deterioration in follow-up performance due to wobbling or the like during curve travel.

### CITATION LIST

### Patent Literature

PTL 1: JP 2001-347850 A
PTL 2: JP 2017-105250 A

### SUMMARY OF INVENTION

### Technical Problem

However, with the vehicle control devices described in PTL 1 and 2 described above, it is not possible to clearly organize how the characteristics of the preceding vehicle affect the follow-up travel of the own vehicle. Therefore, for example, when the preceding vehicle is a large vehicle that blocks the visibility of the own vehicle, it is not possible to secure the visibility of the own vehicle only by detecting acceleration and deceleration, and there is a risk of overlooking signs and traffic signals by hiding in the blind spot of the preceding vehicle being a large vehicle. In addition, only with the shape data of the preceding vehicle, it is difficult to identify that the driver or the driving method of the preceding vehicle has an unfavorable driving tendency from the viewpoint of energy saving, such as increasing the energy consumption of the own vehicle, or the driver or the driving method of the preceding vehicle is a driver or a driving method that frequently causes sudden braking.

The present invention has been made in view of the above circumstances, and has an object to provide a travel control device and a travel control method capable of achieving both securing safety and energy saving at the time of following a preceding vehicle.

### Solution to Problem

In order to achieve the above object, the travel control device according to the first aspect includes: an extraction unit configured to extract a dynamic feature amount of a preceding vehicle which depends on movement of the preceding vehicle that precedes an own vehicle, and a static feature amount of the preceding vehicle which does not depend on movement of the preceding vehicle; a classification unit configured to classify the preceding vehicle based on the dynamic feature amount and the static feature amount; and a planning unit configured to create a travel plan for the own vehicle based on a classification result of the preceding vehicle.

### Advantageous Effects of Invention

According to the present invention, it is possible to achieve both securing safety and energy saving at the time of following a preceding vehicle.

### BRIEF DESCRIPTION OF DRAWINGS

FIG. 1 is a block diagram showing a configuration of a travel control system to which the travel control device according to a first embodiment is applied.

FIG. 2 is a diagram showing an example of a method of detecting a dynamic feature amount of a preceding vehicle executed by the travel control device in FIG. 1.

FIG. 3 is a diagram showing another example of a method of detecting a dynamic feature amount of a preceding vehicle executed by the travel control device in FIG. 1.

FIG. 4 is a diagram showing an example of a travel plan based on the classification result of the preceding vehicle determined by the travel control device according to the first embodiment.

FIG. 5 is a diagram showing an example of safety-oriented correction executed by the travel control device in FIG. 1.

FIG. 6 is a diagram showing an example of the relationship between the speed of the own vehicle corresponding to the travel plan in FIG. 4 and the distance to the preceding vehicle.

FIG. 7 is a diagram showing an example of a travel plan based on the classification result of the preceding vehicle determined by the travel control device according to a second embodiment.

FIG. 8 is a diagram showing an example of a method of determining whether or not to change lanes executed by the travel control device according to the second embodiment.

FIG. 9 is a flowchart showing a method of classifying preceding vehicles executed by the travel control device according to a third embodiment.

FIG. 10 is a diagram showing an example of setting a threshold value of the dynamic feature amount used in the travel control device according to the third embodiment.

FIG. 11 is a diagram showing an example of a method of detecting the dynamic feature amount of the preceding vehicle executed by the travel control device according to a fourth embodiment.

FIG. 12 is a diagram showing an example of a travel plan based on the classification result of the preceding vehicle determined by the travel control device according to the fourth embodiment.

FIG. 13 is a diagram showing an example of a travel plan based on the classification result of the preceding vehicle determined by the travel control device according to a fifth embodiment.

FIG. 14 is a block diagram showing a hardware configuration example of the travel control device in FIG. 1.

### DESCRIPTION OF EMBODIMENTS

Embodiments will be described with reference to the drawings. It should be noted that the embodiments described hereinafter do not limit the invention according to the claims, and not all of the elements and combinations thereof described in the embodiments are indispensable for the means for solving the invention.

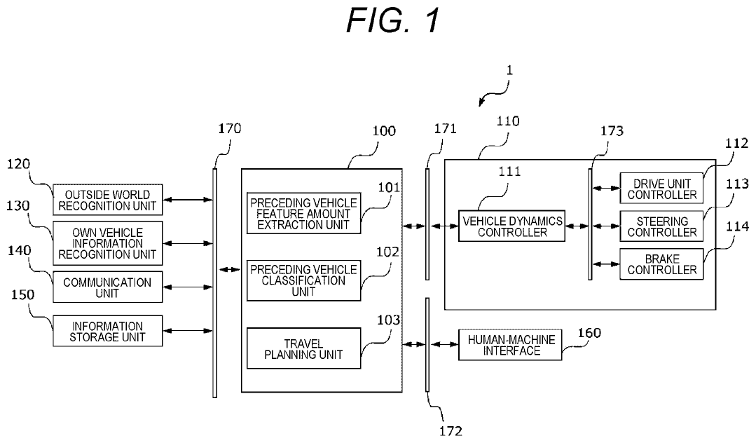

FIG. 1 is a block diagram showing a configuration of a travel control system to which the travel control device according to the first embodiment is applied.

In FIG. 1, the travel control system 1 includes a travel control device 100, a travel execution unit 110, an outside world recognition unit 120, a vehicle information acquisition unit 130, a communication unit 140, an information storage unit 150, and a human-machine interface 160. The travel control system 1 is mounted on the vehicle.

The travel control device 100, the outside world recognition unit 120, the vehicle information acquisition unit 130, the communication unit 140, and the information storage unit 150 are connected to each other via the communication network 170. The travel control device 100 and the travel execution unit 110 are connected to each other via the communication network 171. The travel control device 100 and the human-machine interface 160 are connected to each other via the communication network 172.

The travel control device 100 includes a preceding vehicle feature amount extraction unit 101, a preceding vehicle classification unit 102, and a travel planning unit 103. The travel control device 100 may be used for driving support with a human driving operation, or may be used for self driving without a human driving operation. The travel execution unit 110 includes a vehicle dynamics controller 111, a drive unit controller 112, a steering controller 113, and a brake controller 114. The vehicle dynamics controller 111, the drive unit controller 112, the steering controller 113, and the brake controller 114 are connected to each other via the communication network 173.

For the communication networks 170 to 173, a communication method such as Control Area Network (CAN) or Ethernet can be suitably used. It should be noted that FIG. 1 shows an example in which the communication networks 170 to 173 are divided, but the communication networks 170 to 173 may be integrated into one communication network. Integrating the communication networks into one allows all the elements to communicate with each other, and the delay in information transmission to be minimized. On the other hand, dividing the communication network allows each element to communicate only with the necessary elements, the amount of data exchanged between the elements to be reduced, and the communication processing to be speeded up.

An imaging device, a radar device, a sonar, or a laser scanner can be suitably used for the outside world recognition unit 120. For example, the imaging device includes a stereo camera using a solid-state image sensing device such as a charge coupled device (CCD) or a complementary metal-oxide semiconductor (CMOS), and detecting visible light and infrared light acquires the road condition in front of the own vehicle, the state of obstacles including the preceding vehicle, regulatory information, environmental condition, and the like. When visible light is detected, the feature amount related to the shape of the object is extracted based on the color difference and the brightness difference. When infrared light is detected, heat radiation is detected by infrared light, and a feature amount related to the shape of the object is extracted from the temperature difference.

In the stereo camera, image sensing devices capable of extracting feature amounts in this way can be installed at any interval. Then, synchronizing the shutters to operate the stereo camera, and obtaining as the parallax the pixel shift amount between, for example, the images shifted to the left and right allows the distance to the preceding vehicle to be calculated. In addition, the direction of the target is calculated based on the information on where such a feature amount exists on the pixels. The outside world recognition unit 120 outputs the information acquired in this way to the travel control device 100.

In addition, the radar device detects obstacles such as other vehicles existing ahead of, lateral to, and behind the own vehicle, and acquires information such as the distance between the own vehicle and the obstacles, and identification information and relative speeds on other vehicles. The radar device includes an oscillator that oscillates radio waves and a receiving unit that receives radio waves, and transmits the radio waves oscillated by the oscillator toward an external space. Part of the oscillated radio wave reaches the object and is detected by the receiving unit as a reflected wave. Modulating the amplitude, frequency, or phase of the radio wave to be transmitted allows the time difference between transmission and reception detected by the correlation between this modulated signal and the signal detected by the receiving unit to be obtained, and the time difference can be converted into the distance to the preceding vehicle.

In addition, transmitting radio waves only in a limited direction and scanning the transmitting direction allows the angle at which an object exists to be detected. The outside world recognition unit 120 outputs the acquired information to the vehicle travel control device 100.

When the outside world recognition unit 120 is a sonar, the detection can be made in the same manner by replacing the radio wave with a sound wave. In addition, when a laser scanner is used, the detection can be made in the same manner by replacing the radio wave with a laser beam.

The own vehicle information recognition unit 130 includes a Global Positioning System (GPS) that detects the position of the own vehicle, in addition to sensors that obtain physical quantity such as a vehicle speed sensor that detects the travel speed of the own vehicle and a steering angle sensor that detects the steering angle of the wheels of the own vehicle. The own vehicle information recognition unit 130 outputs the detected speed of the own vehicle, the steering angle of the steering wheel, and the positional information on the own vehicle to the travel control device 100.

The communication device 140 transmits and receives information, and for example, acquires information about the traveling route of the own vehicle by communicating with the control center, acquires the travel speed of surrounding vehicles by communicating with other vehicles traveling around the own vehicle, and acquires information such as the indication of traffic signals and the remaining time until the indication is completed, by directly communicating with the infrastructure information center, traffic lights installed at intersections, or similar infrastructure. The communication device 140 outputs the acquired information to the travel control device 100. In this communication, radio waves such as a mobile phone network or WiFi or optical beacons can be used.

The information storage unit 150 holds map information and records the travel history of the own vehicle. The information storage unit 150 mainly includes a semiconductor memory, a hard disk device, and the like. The map information can be updated by wireless communication or wired communication via the communication unit 140. In addition, the travel history of the own vehicle may be transmitted and received via the communication unit 140 triggered by an appropriate cycle or event. For example, storing a large amount of data exceeding the storage capacity of the information storage unit 150 in a data center (not shown) or the like allows the amount of semiconductor memory used in the information storage unit 150 to be reduced and the cost to be reduced. In addition, requesting the data center for statistical processing that is difficult to process with the microcomputer mounted on the vehicle makes it no longer necessary to mount a microcomputer with high processing capacity on the vehicle and makes it possible to save the power of the travel control device 100 and to reduce the cost thereof.

The human-machine interface 160 displays and notifies various control states according to a control command from the travel control device 100, and accepts input by the driver. For the input from the driver, a lever, a button, or the like provided on the side of the steering column, front side and back side of the steering wheel, the dashboard, or the instrument panel may be used, and a mechanism that can set two states of ON or OFF or more states with contacts, such as a toggle switch, a rocker switch, a slide switch, or a pushbutton switch, a mechanism that can select a plurality of discrete states or continuous states, such as a volume or a slider, a sound collecting device such as a microphone, or an imaging device capable of identifying gestures may be used. Thus, for example, the driver can input a destination point, or a target speed described below via the operation of buttons or levers, the voice input, or the gesture.

As means of notification, a method using voice or sound using a speaker device, those capable of transmitting information to the driver by vision such as lighting devices or display devices, those notifying the driver by vibration or temperature, and the like are assumed. The means of input or notification may be configured to serve as both notification to the driver and reception of operations from the driver, such as a touch panel. Thus, the size of the device can be reduced.

The travel control device 100 executes travel control including autonomous travel of the vehicle in cooperation with the travel execution unit 110 and the like based on the detection information of the on-board radar or sensor. At this time, the travel control device 100 can execute the follow-up control that causes the own vehicle to follow the preceding vehicle that precedes the own vehicle.

The preceding vehicle feature amount extraction unit 101 extracts the dynamic feature amount of the preceding vehicle that depends on the movement of the preceding vehicle and the static feature amount of the preceding vehicle that does not depend on the movement of the preceding vehicle. The dynamic feature amount is, for example, the acceleration, speed, or jerk in the vehicle length direction of the preceding vehicle. The static feature amount is, for example, the vehicle width, the vehicle height, or rear projection area of the preceding vehicle. The preceding vehicle classification unit 102 classifies the preceding vehicle based on the dynamic feature amount and the static feature amount extracted by the preceding vehicle feature amount extraction unit 101. The travel planning unit 103 creates a travel plan for the own vehicle based on the classification result of the preceding vehicle classified by the preceding vehicle classification unit 102. The travel plan is, for example, normal follow-up control, energy saving-oriented correction, safety-oriented correction, or lane change. The safety-oriented correction is a correction that increases the inter-vehicle distance between the own vehicle and the preceding vehicle. The energy saving-oriented correction is a correction that expands the time distance between the own vehicle and the preceding vehicle.

The travel execution unit 110 executes the travel of the own vehicle based on the travel control by the travel control device 100. According to the driving operation entered by the driver through the human-machine interface 160, the vehicle dynamics controller 111 calculates the driving force to achieve the acceleration desired by the driver and transmits a command value to the drive unit controller 112, calculates the steering angle required to turn the vehicle in the direction desired by the driver and transmits a command value to the steering controller 113, and calculates the braking force required to decelerate or stop the vehicle and transmits a command value to the brake controller 114, for example.

It should be noted that when the travel control device 100 has charge of part or the whole of the travel control in place of the driver, the acceleration and direction desired by the driver are replaced by the target values calculated by the travel control device 100. Alternatively, instead of determining the acceleration, a target speed may be set and the acceleration may be calculated so as to follow the target speed.

This target speed may be set to maintain the speed at the time instructed via the human-machine interface 160 by the driver to automatically maintain the speed, and may be set to any value by the input into the human-machine interface 160 by the driver. In addition, the speed limit of the traveling route recorded in the communication unit 140 or the information storage unit 150 described above may be used for this target speed.

Furthermore, the target speed may be automatically set to safely cause the own vehicle to travel against obstacles (for example, a preceding vehicle or a stop line) in front of the vehicle obtained via the outside world recognition unit 120. Specifically, when the obstacle is a preceding vehicle, the inter-vehicle distance capable of avoiding a collision with the preceding vehicle is set as a target inter-vehicle distance, and further, is compared with the target inter-vehicle distance set as the inter-vehicle distance obtained via the outside world recognition unit 120. When the obtained inter-vehicle distance is larger than the target inter-vehicle distance, the target speed is set to a value larger than the current target speed in order to shorten the inter-vehicle distance.

On the other hand, when the obtained inter-vehicle distance is smaller than the target inter-vehicle distance, the target speed is set to a value smaller than the current target speed in order to increase the inter-vehicle distance.

Such a target inter-vehicle distance is set according to the speed of the own vehicle obtained through the own vehicle information acquisition unit 130. Normally, it is considered that the driver follows the preceding vehicle at an inter-vehicle time of about 2 seconds from the preceding vehicle. Therefore, the target inter-vehicle distance is set based on this inter-vehicle time. The inter-vehicle time is defined as the value obtained by dividing the inter-vehicle distance by the travel speed of the own vehicle. It should be noted that since not all drivers drive a car while keeping the inter-vehicle time at 2 seconds, it doesn't matter to have a configuration in which a plurality of inter-vehicle times can be selected according to the driver's preference. For example, the inter-vehicle time may be set to any value between 0.8 seconds and 4 seconds. For example, three stages of short, medium, and long may be selected, and five stages may be selected, but in order to reduce the troublesome operation, it is suitable to divide into about three stages.

When the vehicle is mounted with an engine (not shown), the drive unit controller 112 controls the output of the engine based on information from various sensors that detect the engine operating condition. Such information includes, for example, the engine speed, the throttle valve opening degree, the own vehicle travel speed, the transmission gear ratio, the temperature of cooling water and oil of the engine, and other vehicles information, and also includes environmental information such as the temperature and pressure of the air to be taken in. In order to achieve the driving force commanded by the vehicle dynamics controller 111, the throttle valve opening control is executed in order to change the intake air amount of the engine. When the amount of air taken into the engine by the throttle valve is changed, the fuel injection amount and the ignition timing of the engine are changed according to the change, and the output control of the engine is performed. Increasing the output of the engine allows the torque for rotating the wheels to increase and the vehicle to be accelerated.

Being commanded by the vehicle dynamics controller 111 to increase the driving force causes the drive unit controller 112 to generate a command to control the throttle valve in the open direction. On the other hand, being commanded to reduce the driving force causes the drive unit controller 112 to reduce the engine output by a method of controlling the throttle valve in the closing direction, retarding the ignition timing, stopping fuel injection, or the like. Furthermore, when the driving force is reduced, the vehicle dynamics controller 111 instructs the driving force to decrease, or instructs the brake controller 114 to increase the braking force.

When a large braking force is not required and the speed can be changed by reducing the driving force, the drive unit controller 112 reduces the driving force by stopping the fuel injection and causes the engine to act as an engine brake, which can achieve economical travel without fuel consumption.

On the other hand, when the vehicle is an electric vehicle mounted with not an engine but a battery and a motor, control is performed based on information from various sensors that detect the state of the battery, the inverter, and the motor. Such information includes, for example, the rotational speed of the motor, the travel speed of the own vehicle, the generated voltage and remaining capacity of the battery, the temperature of the inverter, the temperature of the motor, the magnitude of the current flowing through the inverter and the motor, and other vehicle information. In order to change the generated torque and the number of revolutions of the motor so as to achieve the driving force commanded by the vehicle dynamics controller 111, frequency control and voltage control of the inverter are executed. Similar to a vehicle mounted with an engine, an increase in the output of the motor increases the torque for rotating the wheels, so that the vehicle can be accelerated. In addition, both the engine and the motor may generate the rotational force of the wheels to accelerate the vehicle.

When the vehicle travels by a motor, being commanded by the vehicle dynamics controller 111 to increase the driving force causes the drive unit controller 112 to increase the output voltage of the inverter and to increase the power frequency as the rotational speed of the motor increases. On the other hand, being commanded to reduce the driving force causes the drive unit controller 112 to reduce the output voltage of the inverter or to stop the application of the voltage, which reduces the output of the motor. Furthermore, when the driving force is reduced, the motor can be acted as a generator according to the increase in the braking force, and regenerating the electric power allows the load generated at the time of power generation to be used as a brake. Recovering the generated power to a battery allows an economical travel.

That is, using the engine brake that stops fuel injection when the vehicle is mounted with an engine and using the regenerative brake when the vehicle is mounted with a motor and battery allows an economical travel that utilizes the inertial force of the vehicle.

Based on the vehicle information such as the speed of the own vehicle, the acceleration in the front, back, and turning directions and the yaw rate of the vehicle, the steering controller 113 drives and controls a steering motor (not shown) in order to achieve the steering angle commanded by the vehicle dynamics controller 111. The electric power steering device detects the steering angle of the wheel by, for example, a steering angle sensor, and drives the motor mounted thereon so that the detected steering angle reaches a desired value.

The brake controller 114 controls, for example, a master cylinder (not shown) in order to achieve the braking force commanded by the vehicle dynamics controller 111. Upon receiving the braking force increase command, the brake controller 114 increases the hydraulic pressure of the master cylinder (not shown) in order to increase the pressing force of the brake pad (not shown). When the pressing pressure of the brake pad increases, the friction braking force that converts the rotational force of the vehicle tire into heat increases, so that the kinetic energy of the vehicle is consumed as heat and the own vehicle is decelerated.

These travel control device 100, vehicle dynamics controller 111, drive unit controller 112, steering controller 113, brake controller 114, and the like can be achieved by a microcomputer that is appropriately combined with, for example, a central processing unit (CPU) that executes operations, a read only memory (ROM) as a secondary storage device that records programs for calculation, and a random access memory (RAM) as a primary storage device for storing the progress of operations and storing temporary control variables. It is suitable to use a memory using a semiconductor for the ROM and the RAM, but a storage medium such as an optical disc or a magnetic disk can also be used for the ROM.

It should be noted that when completing the control processing to cut off the power, or when going into a hibernation state where the main operation is not performed in a low power consumption state, the microcomputer that constitutes these control units may be configured to store the operation result, learning result, event record, and the like in the hard disk or writable flash memory and to reuse the stored result at the next boot.

As described above, according to the first embodiment described above, the preceding vehicle feature amount extraction unit 101 extracts the dynamic and static feature amount of the preceding vehicle based on the information transmitted from the outside world recognition unit 120, the own vehicle information recognition unit 130, the communication unit 140, and the information storage unit 150, the preceding vehicle classification unit 102 classifies the preceding vehicle based on the feature amount of the preceding vehicle obtained from the preceding vehicle feature amount extraction unit 101, and the travel planning unit 103 corrects the inter-vehicle distance or inter-vehicle time at the time of following the preceding vehicle, or proposes a lane change to an adjacent lane based on the classification result of the preceding vehicle classification unit 102.

Thus, it is possible to clearly organize how the feature of the preceding vehicle affect the follow-up travel of the own vehicle, and to accurately determine whether the inter-vehicle distance should be increased to secure good visibility for the preceding vehicle that the own vehicle follows, the inter-vehicle time Should be increased to avoid excessive increase in the energy consumption of the own vehicle, or the lane change is appropriate. Therefore, it is possible to achieve both improvement of safety performance by securing visibility around the own vehicle and travel with low energy consumption for the own vehicle.

Hereinafter, a method in which the preceding vehicle feature amount extraction unit 101 extracts the feature amount of the preceding vehicle based on the information acquired through the outside world recognition unit 120 will be specifically described.

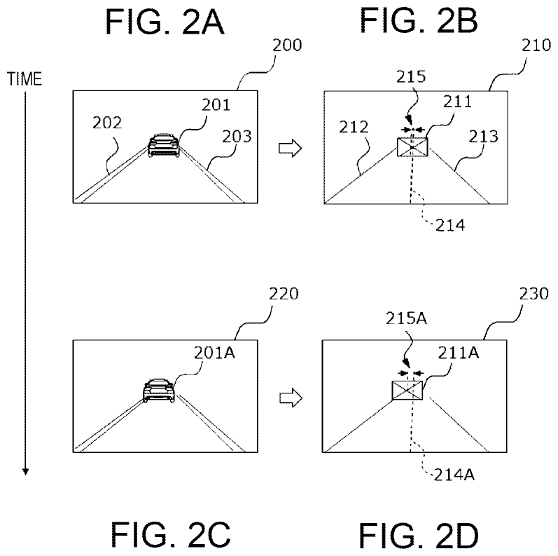

FIG. 2 is a diagram showing an example of a preceding vehicle detection method applicable to the travel control device in FIG. 1. It should be noted that FIG. 2 shows an example in which acquiring the image information in front of the own vehicle via the outside world recognition unit 120 in FIG. 1 extracts the dynamic feature amount of the preceding vehicle.

As shown in FIG. 2(a), at a certain time, the outside world recognition unit 120 acquires image information 200 including: the road in front of the own vehicle, an image 201 of the preceding vehicle that precedes the own vehicle on the road on which the own vehicle travels, and images 202 and 203 of the white lines. It should be noted that in reality, various images such as other vehicles traveling on the road, adjacent lanes of the route on which the own vehicle travels, obstacles existing along the road and in the distant view thereof, and the like are acquired, but they are omitted because they have nothing to do with the description of the present embodiment. Such obstacles and other vehicles may be recognized.

As shown in FIG. 2(b), the preceding vehicle feature amount extraction unit 101 generates the identification result 210 of various quantities included in the image information 200 based on the image information 200 acquired from the outside world recognition unit 120 and the own vehicle information acquired from the own vehicle information recognition unit 130. At this time, the identification result 210 includes the rectangle 211 being the identification result of the preceding vehicle, and the solid lines 212 and 213 being the identification results of the white lines that partition the traveling route of the own vehicle. The identification result 210 can include a broken line 214 indicating the center position of the own vehicle extending in the traveling direction of the own vehicle.

Next, as shown in FIG. 2(c), the outside world recognition unit 120 acquires the image information 220 including the image of the preceding vehicle 201A in front of the own vehicle after the elapse of predetermined time from the acquisition time of the image information 200.

As shown in FIG. 2(d), the preceding vehicle feature amount extraction unit 101 generates the identification result 230 of various quantities included in the image information 220 based on the image information 220 acquired from the outside world recognition unit 120 and the own vehicle information acquired from the own vehicle information recognition unit 130. At this time, the identification result 230 includes a rectangle 211A being an identification result of the preceding vehicle 201A, a broken line 214A indicating the center position of the own vehicle extended in the traveling direction of the own vehicle, and the like.

The above-described predetermined time is, for example, a value of 20 ms or 100 ms, and is suitably set between 1 ms and 1000 ms. Measurement in an extremely short cycle requires a high processing capacity of the device, resulting in an increase in cost. On the other hand, measurement in a long cycle loses the real-time property of the speed of the preceding vehicle, resulting in difficulty in coping with the sudden braking of the preceding vehicle.

While the own vehicle and the preceding vehicle travel, the traveling state always changes, so that the image information obtained through the outside world recognition unit 120 changes. As described above, the relative position between the own vehicle and the preceding vehicle, that is, the inter-vehicle distance can be acquired from the rectangle 211 being the identification result of the preceding vehicle. This inter-vehicle distances are calculated from the acquisition time of the image information 200 in FIG. 2(a) and the acquisition time of the image information 220 in FIG. 2(c), and a relative speed with the preceding vehicle can be acquired due to the change in each inter-vehicle distance and the difference between the acquired times. Furthermore, taking into account the speed of the own vehicle obtained by the own vehicle information recognition unit 130 allows the travel speed of the preceding vehicle to be acquired. Repeating this calculation acquires the change in the speed of the preceding vehicle as the acceleration of the preceding vehicle in the vehicle length direction.

In addition, in consideration of the fact that the measurement result of the inter-vehicle distance includes some error, the obtained speed may be filtered. For example, a low-pass filter that employs only a transmission component of 1 Hz to 10 Hz or less may be provided. With this filtering, it is possible to prevent the acceleration from being overestimated or underestimated due to the measurement error of the inter-vehicle distance and to prevent erroneous recognition as if the preceding vehicle always accelerates or decelerates although the preceding vehicle travels at a constant speed. With the above processing, the preceding vehicle feature amount extraction unit 101 acquires the speed and acceleration in the vehicle length direction of the preceding vehicle as the dynamic feature amount of the preceding vehicle.

In addition, the preceding vehicle feature amount extraction unit 101 acquires the horizontal displacement amount 215 between the broken line 214 being an extension of the center line of the own vehicle in FIG. 2(b) and the center of the rectangle 211 being the identification result of the preceding vehicle, and acquires the horizontal displacement amount 215A after a predetermined time between the broken line 214A being an extension of the center line of the own vehicle in FIG. 2(d) and the center of the rectangle 211A being the identification result of the preceding vehicle after a predetermined time, which makes it possible to acquire the moving speed and acceleration in the vehicle width direction of the preceding vehicle. With the above processing, the preceding vehicle feature amount acquisition unit 101 acquires the moving speed and acceleration in the vehicle width direction of the preceding vehicle as the dynamic feature amount of the preceding vehicle.

It should be noted that although an example of obtaining the moving speed in the vehicle width direction of the preceding vehicle is shown with the broken line 214 as the center line of the own vehicle, the center of the lane determined by the solid lines 212 and 213 may be used as a reference. For example, the solid lines 212 and 213 can be assumed as substantially parallel lane partitioning lines, and the continuous line at the midpoint of the partitioning lines can be assumed as the center line. Thus, it is possible to calculate the moving speed in the width direction of the preceding vehicle regardless of the state of the own vehicle.

On the other hand, using the extension of the center line of the own vehicle, that is, the broken line 214 allows the moving speed in the vehicle width direction of the preceding vehicle to be calculated even if the solid lines 212 and 213 cannot be recognized. These methods may be properly used depending on the situation. When these methods are switched, reset processing may be performed. Thus, it is possible to prevent the speed in the vehicle width direction of the preceding vehicle from excessively being overestimated or underestimated.

The lengths in the height direction and the vehicle width direction of the rectangle 211 being the identification result of the preceding vehicle can be converted into the vehicle height and the vehicle width of the preceding vehicle. From the information, the rectangle 211 can be acquired as an approximate value of the rear projection area of the preceding vehicle.

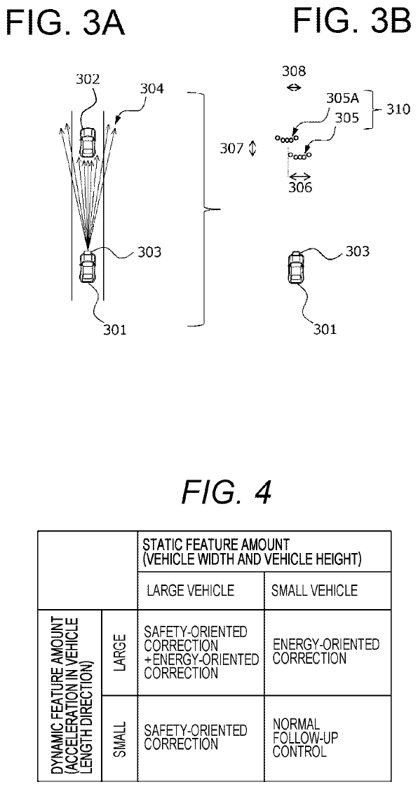

FIG. 3 is a diagram showing another example of a preceding vehicle detection method applicable to the travel control device in FIG. 1. It should be noted that FIG. 3 shows an example of extracting the dynamic feature amount of the preceding vehicle by using a radar, sonar, or a laser scanner as the outside world recognition unit 120 in FIG. 1.

In FIG. 3(a), the own vehicle 301 includes a laser scanner 303 as the outside world recognition unit 120. When the own vehicle 301 follows the preceding vehicle 302, a laser beam 304 is oscillated forward by the laser scanner 303. The laser beam 304 is applied at different angles for each oscillation, and is scanned centering on the front of the own vehicle 301.

Based on the detection result of the reflected light of the laser beam 304 applied to the rear portion of the preceding vehicle 302, the laser scanner 303 identifies the preceding vehicle 302 as point group information 305, as shown in FIG. 3(b). The laser scanner 303 performs the detection by scanning the laser beam 304 again after a predetermined time, thereby identifying the preceding vehicle 302 as the point group information 305A.

The preceding vehicle feature amount extraction unit 101 superimposes the point group information 305 and 305A, thereby generating superimposition information 310. Then, the preceding vehicle feature amount extraction unit 101 acquires the movement amount 307 in the vehicle length direction and the movement amount 308 in the vehicle width direction of the preceding vehicle 302 based on the speed of the point group information 305 and 305A and the own vehicle 301 acquired from the own vehicle information recognition unit 130 on the own vehicle 301. Differentiating these movement amounts 307 and 308 with respect to time allows the speed and acceleration in the vehicle length direction and the vehicle width direction of the preceding vehicle 302 to be acquired.

In addition, the vehicle width of the preceding vehicle 302 can be acquired based on the detection range 306 of the point group information 305 and the inter-vehicle distance to the preceding vehicle 302. In the example in FIG. 3, the process of scanning the laser beam in the vehicle width direction of the own vehicle 301 is described, but scanning also in the height direction of the own vehicle 301 or installing a plurality of laser scanners 303 in the height direction allows the height of the preceding vehicle 302 to be acquired from the detection result of the point group information.

The speeds and accelerations in the vehicle length direction and the vehicle width direction of the preceding vehicle 301 obtained as described above are feature amounts closely related to the traveling state of the preceding vehicle 301 and the characteristics of the driver and the control device for driving the preceding vehicle 301. The preceding vehicle feature amount extraction unit 101 acquires the speeds and accelerations in the vehicle length direction and the vehicle width direction of the preceding vehicle 301 as the dynamic feature amount of the preceding vehicle 301, and acquires the vehicle width, height, and rear projection area of the preceding vehicle 201 as the static feature amount of the preceding vehicle 301.

Hereinafter, based on the dynamic feature amount and the static feature amount of the preceding vehicle acquired through the preceding vehicle feature amount extraction unit 101, the method of classifying the preceding vehicle by the preceding vehicle classification unit 102 and the method of creating the travel plan by the travel planning unit 103 will be specifically described.

FIG. 4 is a diagram showing an example of a travel plan based on the classification result of the preceding vehicle determined by the travel control device according to the first embodiment. It should be noted that FIG. 4 shows an example of using the acceleration in the vehicle length direction as the dynamic feature amount of the preceding vehicle, and the vehicle height and vehicle width as the static feature amount of the preceding vehicle, in order to classify the preceding vehicle.

In FIG. 4, the preceding vehicle classification unit 102 in FIG. 1 acquires the acceleration of the preceding vehicle as a dynamic feature amount, takes an absolute value, and compares it with a predetermined threshold value. Then, based on whether or not the absolute value of the acceleration of the preceding vehicle exceeds the threshold value, the preceding vehicle is classified into large or small, for example. The predetermined threshold value is set based on the acceleration when the own vehicle performs acceleration and deceleration control, and is set to a value such as 0.08 G, 0.1 G, or 0.12 G. The preceding vehicle that accelerates or decelerates at an acceleration larger than this threshold value is determined to be large in acceleration in the vehicle length direction set as a dynamic feature amount.

On the other hand, the preceding vehicle classification unit 102 acquires the vehicle width and the vehicle height of the preceding vehicle as static feature amounts and compares them with predetermined values. For example, the predetermined value of the vehicle width is set to 1.9 m or 2.5 m, and the predetermined value of the vehicle height is set to 2.1 m or 2.5 m. When any one value of the vehicle width and the vehicle height exceeds the predetermined value, the preceding vehicle is classified as a large vehicle, and when both values are less than the predetermined values, the preceding vehicle is classified as a small vehicle.

The travel planning unit 103 determines the travel plan from the four classification results that combine these two classifications. For example, planned is continuation of normal follow-up control, follow-up travel that targets the inter-vehicle distance applied with energy-oriented correction, follow-up travel that targets the inter-vehicle distance applied with safety-oriented correction, or lane change to the adjacent lane. The energy-oriented correction is a correction of the inter-vehicle distance oriented toward energy saving. The safety-oriented correction is a correction of the inter-vehicle distance oriented toward securing the front visibility of the own vehicle.

In the energy-oriented correction, it is effective to suppress the fluctuation of the vehicle speed of the own vehicle in order to improve the energy saving of the own vehicle. The own vehicle needs to increase the output of the driving force source in order to increase the travel speed, that is, to accelerate. An increase in the output of the driving force source leads to an increase in fuel consumption or an increase in power consumption.

On the other hand, in order for the own vehicle to reduce the travel speed, that is, to decelerate, it is necessary to consume the acquired kinetic energy. In addition, even when traveling at a constant speed without acceleration or deceleration, the rolling resistance between the road surface and wheels, the air resistance of the vehicle, and furthermore, the tangential component of gravity along a slope when climbing the slope act as travel resistances, so that the output of the driving force source cannot be reduced to zero. Ideally, performing the acceleration minimally necessary for the travel of the own vehicle acquires kinetic energy, and using the acquired kinetic energy as much as possible for advancing the vehicle achieves a travel oriented toward energy-saving.

The speed change of the own vehicle is achieved under the time delay existing in the travel execution unit 110 in FIG. 1. For example, there exists a delay until the output of the engine or motor increases, the driving force increases, and the vehicle moves forward, a delay until the brake oil pressure rises and the brake pads are pressed, and the like. Therefore, it is necessary to have some temporal margin to change the speed of the own vehicle, and for this index, it is suitable to perform evaluation by a scale based on the inter-vehicle time obtained by dividing the inter-vehicle distance between the own vehicle and the preceding vehicle by the traveling speed.

When the own vehicle follows the preceding vehicle, increasing the inter-vehicle time to the preceding vehicle so that the speed fluctuation due to acceleration and deceleration of the preceding vehicle is propagated to the own vehicle without being amplified as much as possible allows the influence of the travel characteristics on the own vehicle can be reduced even when the preceding vehicle exhibits travel characteristics unfavorable for the energy consumption of the own vehicle. When the energy-oriented correction is selected, modifying the inter-vehicle distance according to the travel speed of the own vehicle so as to increase the inter-vehicle time allows the increase in energy consumption due to repeated acceleration and deceleration to be prevented.

For example, when the basic inter-vehicle distance is set so that the inter-vehicle time is 2 seconds, adding the inter-vehicle time of, for example, 0.2 seconds, 0.5 seconds, or 1 second to this basic inter-vehicle distance increases the inter-vehicle time to be the target. This value is suitably between 0.1 seconds and 2 seconds. In addition to the method of increasing by a predetermined value, a correction may be made so as to multiply the inter-vehicle time of 2 seconds by a predetermined value of 1.05, 1.1, or 1.4. A magnification between 1.01 times and 2.0 times can be suitably used for this predetermined value. The relationship between the inter-vehicle time and the inter-vehicle distance can be given by the following FORMULA 1, and the target inter-vehicle distance can be calculated from the travel speed of the own vehicle.

L=v·THW, (FORMULA 1)

where L is the inter-vehicle distance, v is the own vehicle speed, and THW is the inter-vehicle time.

It should be noted that in FORMULA 1, when the vehicle speed v is 0, the inter-vehicle distance L is also 0. Therefore, as the inter-vehicle distance during the stopping when the own vehicle speed v becomes 0, a safety margin L₀ is set as shown in FORMULA 2 below.

L=v·THW+L₀ (FORMULA 2)

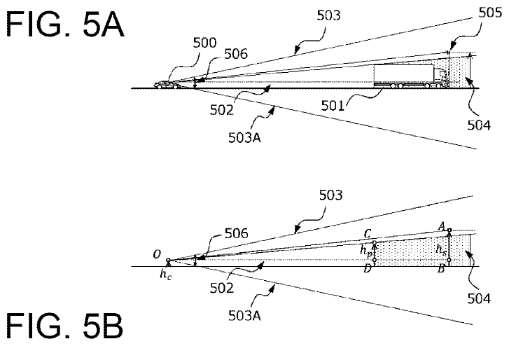

FIG. 5 is a diagram showing an example of safety-oriented correction executed by the travel control device in FIG. 1. It should be noted that FIG. 5 shows an example of performing safety-oriented correction using a stereo camera as the outside world recognition unit 120 in FIG. 1.

In FIG. 5(a), it is assumed that the stereo camera being the outside world recognition unit 120 is installed on the upper portion of the windshield of the own vehicle 500. The detection range is the area surrounded by the solid lines 503 and 503A determined by the angle of view 506 in the height direction centered on the broken line 502 indicating the center of the optical axis of the stereo camera.

Then, the own vehicle 500 is assumed to follow the large preceding vehicle 501. At this time, the image projected on the image sensing device of the stereo camera set as the outside world recognition unit 120 is concealed by the rear portion of the preceding vehicle 501. Therefore, it is impossible to detect a target existing in the region 504 in front of the preceding vehicle 501. The own vehicle 500 corrects the inter-vehicle distance to the preceding vehicle 501 in order to include the traffic light 505 to be detected in the detection range while following the preceding vehicle 501, for example.

As shown in FIG. 5(b), when the position of the image sensing device of the stereo camera set as the outside world recognition unit 120 is set as a point O, it is assumed that a point D as the rear end portion of the preceding vehicle 501 and a point B being the existing point of the traffic light 505 are taken on the center of the optical axis, and a point C being the maximum height of the rear end portion of the preceding vehicle 501 and a point A as the position where the light of the traffic light 505 exists are taken.

In this case, if the triangle OAB and the triangle OCD are similar figures, the light of the traffic light 505 cannot be checked. On the other hand, as long as the angle AOB>the angle COD, the own vehicle 500 can check the light of the traffic light 505. That is, when the angle AOB is not less than the angle formed by the center of the optical axis 502 and the solid line 503, the light of the traffic light 505 cannot be checked. Therefore, the angle AOB, at which the light of the traffic light 505 can be checked, is required to satisfy the condition of θ>angle AOB>angle COD, where θ is the angle formed between the center of the optical axis 502 and the solid line 503, that is, half of the angle of view 506.

In order to be able to check the light of the traffic light 505, to satisfy this condition, the target inter-vehicle distance, that is, the length of the line segment OD has only to be obtained. The height where the light point of the traffic light 505 exists at the position where the light of the traffic light 505 is desired to be checked (line segment OB) is assumed to be hₛ, the height above ground of the image sensing device of the stereo camera of the own vehicle 500 is assumed to be h_{c}, and the vehicle height of the preceding vehicle 501 is assumed to be hₚ, then the condition of θ>angle AOB>angle COD can be given by the following FORMULA 3, where L_{A} is the length of the line segment AB, L_{B} is the length of the line segment OB, L_{C} is the length of the line segment CD, and L_{D} is the length of the line segment OD.

tan(θ)>tan(L_{A}/L_{B})>tan(L_{C}/L_{D}) (FORMULA 3)

From FORMULA 3, the length of the line segment OD can be given by FORMULA 4 below.

L_{D}>L_{B}·(hₛ−h_{c})/(hₚ−h_{c}) (FORMULA 4)

The right side of FORMULA 4 is the value obtained by multiplying the position where the light of the traffic light 505 is desired to be checked by the ratio of the value obtained by subtracting the height of the optical axis center line from the height where the light point of the traffic light 505 exists to the value obtained by subtracting the height of the optical axis center line from the vehicle height of the preceding vehicle 501. Therefore, the inter-vehicle distance set by the safety-oriented correction changes depending on the position where the light of the traffic light 505 is desired to be checked. At this time, always calculating the own vehicle position with respect to the traffic light 505 and changing the distance corresponding to the line segment OB makes the inter-vehicle distance corrected by the safety-oriented correction longer as the distance from the traffic light 505 increases.

For this reason, it is not suitable to perform safety-oriented correction so that the light of the traffic light 505 can always be checked while constantly updating the relationship between the traffic light 505 and the own vehicle position, and a method of determining the position where the light of the traffic light 505 is desired to be checked for each traffic light and fixing the position until the intersection is passed is suitable. In such a method of determining the position, it is suitable to calculate and use: the detection distance of the image sensing device used as the outside world recognition unit 120, the distance within which the own vehicle can stop at the stop line when decelerating at a predetermined acceleration from the speed limit of the route on which the own vehicle travels, or the like. Setting a longer distance, among the inter-vehicle distance obtained in this way and the basic inter-vehicle distance during the follow-up travel, as the target inter-vehicle distance allows the safety-oriented correction to be performed.

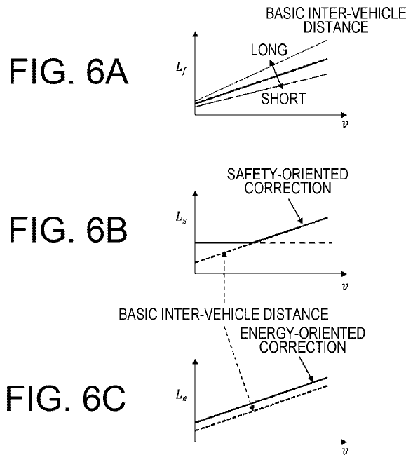

FIG. 6 is a diagram showing an example of the relationship between the speed of the own vehicle corresponding to the travel plan in FIG. 4 and the distance to the preceding vehicle.

In FIG. 6(a), the basic inter-vehicle distance L_{f} is proportional to the own vehicle speed v. When the basic inter-vehicle distance L_{f} is lengthened, the inclination with respect to the own vehicle speed v is increased, and when the basic inter-vehicle distance L_{f} is shortened, the inclination with respect to the own vehicle speed v is decreased.

As shown in FIG. 6(b), in a range where the own vehicle speed v is not more than a predetermined value, the inter-vehicle distance Lₛ by safety-oriented correction is corrected by comparison with the distance geometrically determined by the position where the light of the signal is desired to be checked, regardless of the own vehicle speed v. On the other hand, as shown in FIG. 6(c), the inter-vehicle distance Lₑ by the energy-oriented correction is corrected so as to increase by a predetermined ratio or width with respect to the basic inter-vehicle distance L_{f}.

It should be noted that in the above-described safety-oriented correction, the case where the own vehicle 500, the preceding vehicle 501, and the traffic light 505 in FIG. 5(a) exist at the same altitude and the optical axis center exists parallel to the road surface is described as an example. However, it is more suitable to make corrections according to altitude differences of these and the elevation angle in the vehicle length direction of the own vehicle, that is, the deviation of the angle between the optical axis center and the road surface. For example, when the stereo camera set as the outside world recognition unit 120 attached to the own vehicle 500 is attached at an elevation angle of 0, that is, when the optical axis center exists horizontally to the road surface, the upper limit θ of the angle is half of the angle of view 506. However, for example, when the outside world recognition unit 120 is installed upward, θ is obtained by adding the elevation angle to the amount larger than half the angle of view 506, and when installed downward, θ is a value obtained by subtracting the elevation angle from half the angle of view 506.

The traffic lights 505 do not always exist at the same height, and the positions that can be observed from the road vary depending on the signal. Storing in advance the height and position of the traffic light 505 in the information storage unit 150 in FIG. 1, acquiring the own vehicle position from the GPS positioning information acquired by the own vehicle information recognition unit 130, and obtaining information on the height and position of the traffic light 505 on the course of the own vehicle 500 based on the own vehicle position makes it possible for the travel planning unit 103 to correct the inter-vehicle distance by safety-oriented correction before the traffic light 505 is detected by the outside world recognition unit 120. When the height and position of the traffic light 505 are acquired in advance, the communication unit 140 may acquire traffic light information on the planned travel route of the own vehicle 500, and when a traffic light is detected by the outside world recognition unit 120, the traffic light information of the traffic light may be stored in the information storage unit 150. At this time, the traffic signal information on the latest 500, 1000, or more pieces may be held in the information storage unit 150, and the old traffic light information may be deleted.

In the method of storing the signal light information on the signal light detected by the outside world recognition unit 120 in the information storage unit 150, it is suitable to run an operation in which at a certain point, the minimum height (for example, 5 m) specified by the Road Structure Ordinance, or the like is set until the traffic light is first observed, and when the traffic light is observed and the traffic light information is accumulated, the correct height is employed. Thus, the correct traffic light information is used for the routes normally used by the own vehicle, such as the commuting route and the area around the base where the own vehicle is mainly used, and since the tentative value is set even in other places, it is possible to perform safety-oriented correction.

It should be noted that in this case, the number of cases where the signal information is stored is appropriately about 500 or 1000. If the number is not less than that, the required storage region will be expanded and the cost will increase. If the number is not more than this, traffic lights whose correct traffic light information can be stored are limited, and the opportunities of safety-oriented correction based on the accurate traffic light height are reduced.

In addition, when the preceding vehicle stops and then the own vehicle also stops, it is not always necessary for the own vehicle to stop so that the detection target obtained as described above is included in the recognition range, and in a low vehicle speed range such as immediately before a stop, it is suitable not to correct the inter-vehicle distance. Thus, it is possible to suppress the behavior of stopping at a distance larger than the vehicle length of the own vehicle 500 from the preceding vehicle 501 when the vehicle is stopped, and it is possible to eliminate the discomfort that the own vehicle 500 stops with such a large space between vehicles. At this time, a method of setting a threshold value for the own vehicle speed obtained from the own vehicle information recognition unit 130 is suitable.

It is suitable that for example, in a case where the traffic light turns red, the preceding vehicle stops, subsequently the own vehicle stops, and the signal light cannot be checked, when the preceding vehicle starts, the own vehicle continues to stop until the signal light can be checked and starts so that the inter-vehicle distance increases while following the preceding vehicle until the own vehicle reaches the stop line. For example, it is possible to have an operation of allowing an increase in the inter-vehicle distance until the inter-vehicle distance increases by the correction amount obtained by the safety-oriented correction as the upper limit. Continuing to stop the own vehicle until the light of the signal can be checked makes it possible to avoid a rear-end collision and improve safety even if the preceding vehicle accidentally starts, and then stops due to sudden braking or the like. On the other hand, when the own vehicle starts while following the preceding vehicle and increasing the inter-vehicle distance, it is expected that the discomfort of a driver of the following vehicle of the own vehicle will be reduced.

These methods may be switched based on the distance to the intersection or the stop line. That is, when there is some distance to the stop line, even if the own vehicle starts following the preceding vehicle, the signal may switch before reaching the stop line, and it is better to be able to check the light of the signal as soon as possible so that this signal switching can be detected. On the other hand, when there is no distance to the stop line, it is considered that the stop line can be reached relatively early when the signal is switched, so that the own vehicle's starting accelerating following the preceding vehicle allows starting without obstructing the flow of traffic.

As described above, the inter-vehicle distance is set by the energy-oriented correction and the safety-oriented correction. Then, in FIG. 4, it is assumed that the “small vehicle” is selected from the static feature amount of the preceding vehicle, and the “acceleration in the vehicle length direction is small” is selected from the dynamic feature amount of the preceding vehicle. In this case, the travel planning unit 103 in FIG. 1 determines the inter-vehicle distance when the own vehicle follows the preceding vehicle according to the normal follow-up control. On the other hand, it is assumed that the “small vehicle” is selected from the static feature amount of the preceding vehicle, and the “acceleration in the vehicle length direction is large” is selected from the dynamic feature amount of the preceding vehicle. In this case, the travel planning unit 103 determines that the travel method of the preceding vehicle is unfavorable from the viewpoint of energy consumption of the own vehicle, and selects the energy-oriented correction.

Furthermore, it is assumed that the “large vehicle” is selected from the static feature amount of the preceding vehicle, and the “acceleration is small” is selected from the dynamic feature amount of the preceding vehicle. In this case, the travel planning unit 103 selects the safety-oriented correction. On the other hand, it is assumed that the “large vehicle” is selected from the static feature amount of the preceding vehicle, and the “acceleration is large” is selected from the dynamic feature amount of the preceding vehicle. In this case, the travel planning unit 103 selects both safety-oriented correction and energy-oriented correction. In this case, the energy-oriented correction is performed on the basic inter-vehicle distance, and the target inter-vehicle distance obtained as a result is compared with the inter-vehicle distance by the safety-oriented correction. Thus, it is possible to travel with suppressing an increase in energy consumption of the own vehicle while securing a front visibility. If such a correction is performed in reverse and the energy-oriented correction is added in a state where the inter-vehicle distance is increased by the safety-oriented correction, the inter-vehicle distance is unnecessarily extended, which is not suitable.

Hereinafter, a modified example of the above-described first embodiment will be described. The description of the portion overlapping with the first embodiment described above will be omitted.

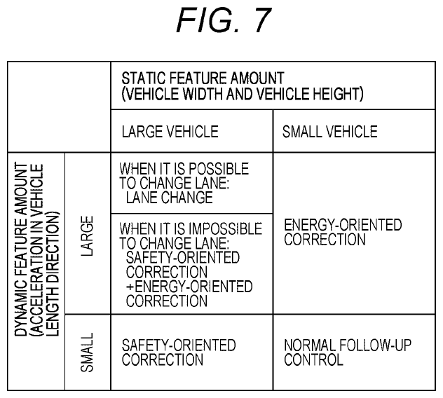

FIG. 7 is a diagram showing an example of a travel plan based on the classification result of the preceding vehicle determined by the travel control device according to the second embodiment. It should be noted that FIG. 7 shows an example in which the case where the lane change can be selected is added to the travel plan in FIG. 4.

In FIG. 7, it is assumed that the “large vehicle” is selected from the static feature amount of the preceding vehicle, and the “acceleration is large” is selected from the dynamic feature amount of the preceding vehicle. In this case, the travel planning unit 103 determines whether or not the lane can be changed to the adjacent lane based on the traveling state of the following vehicle traveling in the adjacent lane adjacent to the travel lane of the own vehicle. Then, the travel planning unit 103 selects the lane change if the lane can be changed to the adjacent lane, and selects both the safety-oriented correction and the energy-oriented correction if the lane cannot be changed to the adjacent lane.

When the “large vehicle” is selected from the static feature amount of the preceding vehicle and the “acceleration is large” is selected from the dynamic feature amount of the preceding vehicle, it is considered that if the preceding vehicle is a freight vehicle, the preceding vehicle is unladen, and if the preceding vehicle is a shared vehicle, the preceding vehicle has no passengers. That is, it is considered that when the weight of the preceding vehicle is light, the braking distance is shorter than usual, and acceleration and deceleration is easier.

In order to determine whether it is possible to change lanes to an adjacent lane, as the outside world recognition unit 120 in FIG. 1, it is needed to provide a plurality of radars or imaging devices so that not only the vehicle in front of the own vehicle but also the vehicles lateral to, posterolateral to, and in back of the own vehicle can be detected.

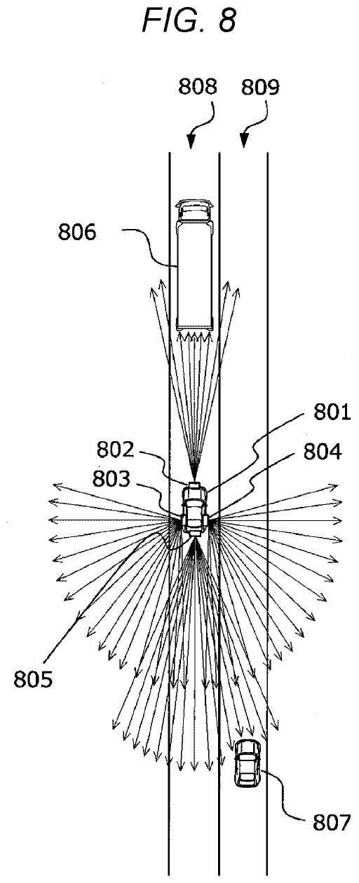

FIG. 8 is a diagram showing an example of a method of determining whether or not to change lanes executed by the travel control device according to the second embodiment. It should be noted that FIG. 8 shows an example of determining whether or not a lane can be changed by using a radar, sonar, or a laser scanner as the outside world recognition unit 120 of FIG. 1.

In FIG. 8, it is assumed that, of the two lanes 808 and 809 in which travel can be made in the same direction, the own vehicle 801 and the preceding vehicle 806 travel in the lane 808, and the following vehicle 807 travels in the lane 809.

The own vehicle 801 includes, as the outside world recognition unit 120, a radar 802 that mainly searches ahead of the own vehicle 801, radars 803 and 804 that can search the lateral sides of the own vehicle 801, and a radar 805 that can search the posterolateral side of the own vehicle 801.

It is assumed that based on the detection result by the radar 802, the preceding vehicle 806 preceding the own vehicle 801 is determined to have a type of a large vehicle as a static feature amount, and to have a large acceleration as a dynamic feature amount. At this time, it is assumed that the own vehicle 801 recognizes the lane 808 in which the own vehicle 801 travels and the lane 809 adjacent to the lane 808. In this case, the own vehicle 801 acquires the position and speed of the vehicles around the own vehicle 801 from any one of the radars 803, 804, and 805. For example, the own vehicle 801 acquires the position and speed of the following vehicle 807 approaching the own vehicle 801 from behind in the lane 809 from any one of the radars 803, 804, and 805.

At this time, the travel planning unit 103 determines whether or not the lane can be changed by the following steps.

(1). A step of detecting information on other vehicles (for example, preceding vehicle 806 and following vehicle 807) in the travel lanes by a radar 802, 803, 804, 805, or the like.

(2). A step of creating a route plan for the own vehicle 801 to continue traveling in the lane 808 without changing lanes.

(3). A step of creating a route plan for the own vehicle 801 to change lanes and to travel in the lane 809.

(4). A step of calculating courses and speeds for the respective vehicles considered to change before the lane change of the own vehicle 801 is completed from the information on other vehicles detected in the processing of (1).

(5). A step of determining whether the own vehicle 801 can safely complete the lane change based on the processing of (2), (3) and (4).

(6). A step of determining whether or not to change lanes based on the determination result of (5).

In the processing of (1), the relative position, travel speed, or acceleration between another vehicle and the own vehicle is acquired by the radars 802, 803, 804, and 805.

In the processing of (2), the route in which the own vehicle 801 continues to travel in the same lane 808 is planned over the time when the own vehicle 801 completes the lane change or later. For example, assuming that the own vehicle 801 continues to travel at the same speed as before, the distance traveled from the current position and the speed are calculated for several seconds needed to complete the lane change, that is, 5 seconds, 8 seconds, 10 seconds, or 20 seconds.

In the processing of (3), as in the processing of (2), the position and speed of the own vehicle are calculated for several seconds needed to complete the lane change.

In the processing of (4), for example, the position and speed to be assumed when the preceding vehicle 806 and the following vehicle 807 in FIG. 8 travel at a constant speed or a constant acceleration are calculated for a few seconds until the own vehicle 801 completes the lane change.

In the processing of (5), from the processing results of (2), (3), and (4), the relative speed between the own vehicle 801 and another vehicle, the collision margin time, or the collision margin, detected for several seconds during which the own vehicle 801 completes the lane change is calculated, and it is determined whether the own vehicle 801 can safely change lanes on the condition that none of the calculated values falls below or exceeds the predetermined value.

In the processing of (6), if it is checked in (5) that the lane can be changed safely, the own vehicle 801 can be controlled to travel on the route planned in the processing of (3), and if it is determined in the processing of (5) that the lane cannot be changed safely, the processing in the travel planning unit 103 is executed so that the own vehicle 801 can be controlled to travel on the route planned in the process of (2).

That is, the travel planning unit 103 acquires the speed and the position relative to the own vehicle or the absolute position, based on the information on the outside world recognition unit 120 of the surrounding vehicle, and determines whether it is possible for the own vehicle to change the lane and generates a plan of the traveling route.

In the processing of (5), the collision margin time TTC can be given by the following FORMULA 5 where dₓ is the inter-vehicle distance, V_{f} is the following vehicle speed, and Vₑ is the own vehicle speed.

TTC=dₓ/(V_{f}−Vₑ) (FORMULA 5)

It is considered that the smaller the collision margin time TTC, the closer the danger of collision of the own vehicle 801 is. Therefore, when the collision margin time TTC falls below the predetermined value, it is considered that the lane change is not safe. For example, when the collision margin time TTC falls below 10 seconds or 15 seconds, or if it falls below the number of seconds considered to complete the lane change, it is considered unsafe to change lanes, so that these values can be set as predetermined values for determining that changing lanes is not safe.

In addition, in the processing of (5), the collision margin MTC can be given by the following FORMULA 6 where α is an acceleration.

MTC=(−dₓ−Vₑ²/(2α))/−(V_{f}²/(2α)) (FORMULA 6)

It can be determined that the smaller the collision margin MTC, the closer the danger of collision of the own vehicle 801 is. For example, when the collision margin MTC is less than 1, it can be determined that changing lanes is not safe.

Alternatively, the following vehicle 807 travels at a higher speed than the own vehicle 801, and it can be determined that the danger of collision is imminent as the relative speed increases. In such a case, when the collision margin MTC falls below the predetermined value, it is determined that the lane change is not safe.

By making such a determination, when the own vehicle 801 has a function of automatically changing lanes in addition to the function of automatically accelerating and decelerating, and when it is determined that it is better to change the lane of the own vehicle and it is possible to change the lane safely based on the dynamic feature amount and the static feature amount of the preceding vehicle 806, it is planned to change the lane of the own vehicle.

It is known that the larger the preceding vehicle, the stronger the driver's motive for increasing the inter-vehicle distance. In addition, since the driver empirically perceives that the acceleration and deceleration of a heavy large vehicle is slow, the driver desires that the own vehicle avoids following the preceding vehicle which is large and has a large acceleration deviated from such a state. Therefore, making it possible to positively change the follow-up target by changing lanes makes it possible to provide follow-up travel with less psychological burden on the driver.

As described above, according to the second embodiment described above, the preceding vehicle classification unit 102 classifies the preceding vehicle based on the dynamic feature amount and the static feature amount of the preceding vehicle. When the acceleration when the preceding vehicle starts is larger than the acceleration when the own vehicle starts, and the vehicle height or vehicle width of the preceding vehicle is larger than a predetermined value, the travel planning unit 103 can select lane change to the adjacent lane adjacent to the travel lane of the own vehicle. Thus, a large vehicle with violent acceleration and deceleration, which causes a psychological burden on the driver, can be positively excluded from the follow-up target of the own vehicle, and an increase in the psychological burden on the driver can be suppressed. On the other hand, for a preceding vehicle in which there is no risk of such an increase in the psychological burden of the driver, it is possible to continue the travel following the preceding vehicle.

It should be noted that when it is determined that the acceleration is large as the dynamic feature amount, in a case where the large vehicle is selected from the classification result based on the static feature amount, a threshold value used for determination in the case of a large vehicle may be prepared in addition to the threshold value based on the acceleration based on the characteristics of the own vehicle.

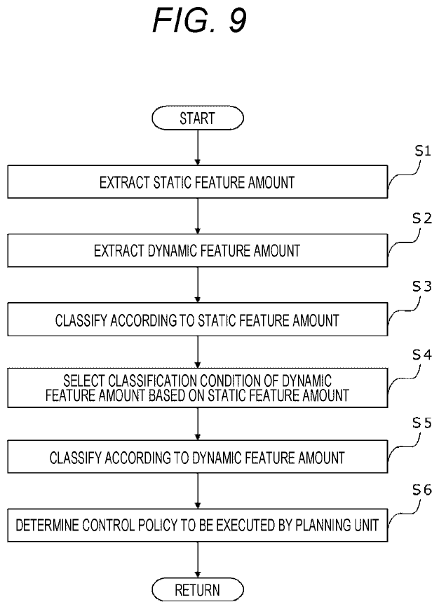

FIG. 9 is a flowchart showing a method of classifying preceding vehicles executed by the travel control device according to the third embodiment.

In FIG. 9, the preceding vehicle feature amount extraction unit 101 in FIG. 1 extracts the static feature amount of the preceding vehicle (S1) and extracts the dynamic feature amount of the preceding vehicle (S2).

Next, the preceding vehicle classification unit 102 classifies the preceding vehicle based on the static feature amount (S3). Next, the preceding vehicle classification unit 102 selects the classification condition of the dynamic feature amount based on the static feature amount (S4), and classifies the preceding vehicle based on the dynamic feature amount (S5). The classification condition of the dynamic feature amount is, for example, the threshold value of the dynamic feature amount. The threshold value of the dynamic feature amount can be set according to the static feature amount. Next, the travel planning unit 103 determines the control policy of the own vehicle based on the classification result of the preceding vehicle (S6).

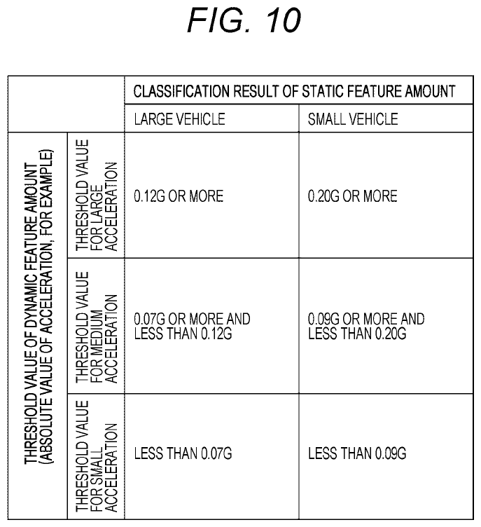

FIG. 10 is a diagram showing an example of setting a threshold value of the dynamic feature amount used in the travel control device according to the third embodiment.

In FIG. 10, as the classification condition of the dynamic feature amount, a combination of a plurality of threshold values can be provided based on the classification result of the static feature amount. At this time, the dynamic feature amount may be classified into three or more according to the classification result of the static feature amount.

For example, assuming that classification of the small vehicle and the large vehicle is made as the classification result of the static feature amount, a threshold value for large acceleration, a threshold value for medium acceleration, and a threshold value for small acceleration can be set for each of the small vehicle and the large vehicle.

Here, performing the classification based on the static feature amount before the classification based on the dynamic feature amount allows the classification conditions for the dynamic feature amount to be selected according to the static feature amount.

Hereinafter, an example of acquiring the acceleration in the vehicle width direction in addition to the acceleration in the vehicle length direction as the dynamic feature amount of the preceding vehicle will be described. An approximate shape of the shape formed when the locus of the acceleration in the vehicle length direction and the acceleration in the vehicle width direction of the preceding vehicle is drawn on a two-dimensional plane over a predetermined time, such as the diagonal length or aspect ratio of the approximate rectangular shape, or the approximate circle radius, is extracted as the dynamic feature amount of the preceding vehicle, and the preceding vehicle is classified.

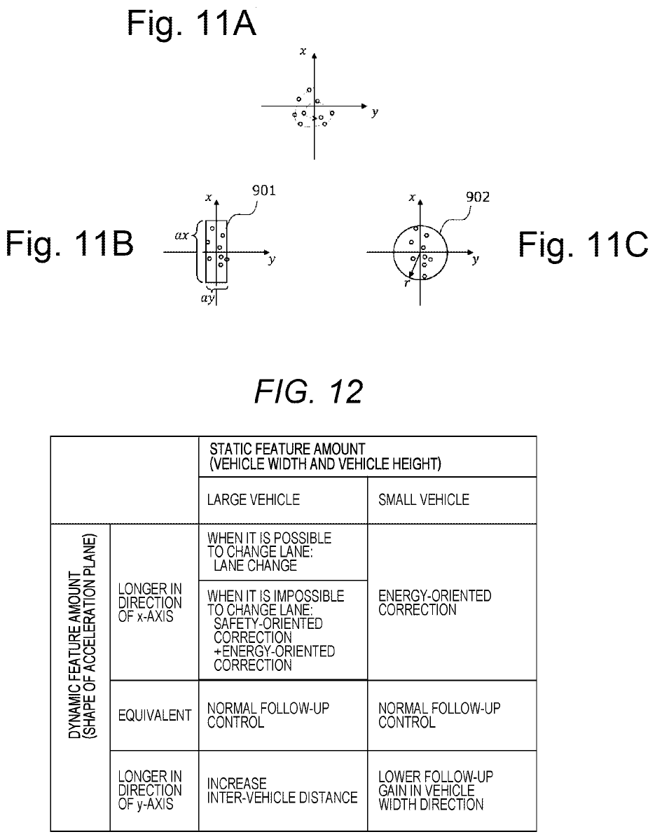

FIG. 11 is a diagram showing an example of a method of detecting the dynamic feature amount of the preceding vehicle executed by the travel control device according to the fourth embodiment. It should be noted that in FIG. 11, an example is shown in which the acceleration in the vehicle length direction is taken on the x-axis and the acceleration in the vehicle width direction is taken on the y-axis.

FIG. 11(a) shows an example in which the acceleration distributions in the vehicle length direction and the vehicle width direction of the own vehicle are drawn on a two-dimensional plane. It should be noted that the broken line arrow indicates that a new detection result point is added in the direction of the arrow. Here, the step sizes of the x-axis and the y-axis are changed so that the travel characteristics of the own vehicle can be approximated to a substantially circular shape. For example, in the x-axis direction, it is scaled with 0.3 G or 0.4 G as the maximum value and −0.3 G or −0.4 G as the minimum value, and in the y-axis direction, it is scaled between −0.2 G and 0.2 G, or −0.4 G and 0.4 G. In FIG. 11, the acceleration generated in the left side direction is described as positive, but the acceleration generated in the left side direction may be described as negative. In addition, in FIG. 11, acceleration is taken as an example, but the same applies also to speed. Furthermore, one axis may represent acceleration and the other axis may represent speed. It only needs to be able to compare the travel characteristics of the preceding vehicle with the travel characteristics of the own vehicle.

For example, as shown in FIG. 11(b), a distribution, in which the acceleration distribution in the vehicle length direction is larger than the acceleration distribution in the vehicle width direction and which has a shape longer in the x-axis direction, is considered to show a driving tendency that causes a large deceleration before entering a curve or when the preceding vehicle catches up with its preceding vehicle, or to show that the driver tends to prefer to drive by generating a large acceleration and deceleration. Therefore, the vehicle speed fluctuation of the preceding vehicle becomes large, and it is highly possible that at the time of follow-up travel, the preceding vehicle takes an unfavorable traveling method from the viewpoint of energy consumption of the own vehicle or makes it difficult for the own vehicle to secure visibility. At this time, changing lanes or performing energy-oriented correction allows the own vehicle to achieve follow-up travel that can secure safety and suppress an increase in energy consumption.

In addition, a distribution, in which the acceleration distribution in the vehicle width direction is larger than the acceleration distribution in the vehicle length direction and which has a shape longer in the y-axis direction, shows a driving tendency of large wobbling, a driving tendency of bulging outward on a curve, a driving tendency of cutting inside the curve, or a driving tendency of the behavior of swinging the head in the opposite direction once when turning left or right. In the case of such a driving tendency, for example, it is highly likely that the driver is a beginner in driving or a driver who tends to avoid an event by operating the steering wheel, and it is considered that the deceleration is delayed in a scene where deceleration is required, or that the occurrence frequency of sudden braking is high. Since a large vehicle is large in vehicle width with respect to the travel lane, correcting so that the inter-vehicle distance increases makes it easier to recognize the travel lane of the own vehicle or lowers the resolution perceived as a movement during traveling, whereby it is possible to reduce wobbling when the own vehicle follows the traveling locus of the preceding vehicle.

On the other hand, since a small vehicle is small in vehicle width with respect to the travel lane, and has a large space to move in the lane even if the inter-vehicle distance increases as with a large vehicle, it is necessary to take larger inter-vehicle distance. Because when the own vehicle follows the wobbling in the vehicle width direction of the small vehicle, a simple increase in the inter-vehicle distance alone may cause the own vehicle also to wobble, at the time of following a preceding vehicle being a small vehicle and having a distribution longer in the y-axis direction, lowering the follow-up gain in the vehicle width direction makes it possible to travel with reduced wobbling.

The acceleration distribution in the vehicle length direction and the vehicle width direction of the preceding vehicle may be evaluated by the diagonal length (ax²+ay²)^{1/2} or the aspect ratio ax ay of the approximate rectangle 901 in FIG. 11(b), or may be evaluated by the radius r of the approximate circle 902 in FIG. 11(c). The acceleration distribution in the vehicle length direction and the vehicle width direction of the preceding vehicle in FIG. 11(b) or FIG. 11(c) can be drawn on a two-dimensional plane with reference to the acceleration in the vehicle length direction and the vehicle width direction of the own vehicle in FIG. 11(a).

FIG. 12 is a diagram showing an example of a travel plan based on the classification result of the preceding vehicle determined by the travel control device according to the fourth embodiment.

In FIG. 12, it is assumed that the “large vehicle” is selected from the static feature amount of the preceding vehicle, and the acceleration distribution of the preceding vehicle is determined to be longer in the y-axis direction (vehicle width direction) than in the x-axis direction (vehicle length direction). At this time, the travel planning unit 103 selects the correction of increasing the inter-vehicle distance between the own vehicle and the preceding vehicle.

It is assumed that the “small vehicle” is selected from the static feature amount of the preceding vehicle, and that the acceleration distribution of the preceding vehicle is longer in the y-axis direction than in the x-axis direction. At this time, the travel planning unit 103 selects the correction of “lowering the follow-up gain in the y-axis direction (vehicle width direction)”. Lowering the follow-up gain in the vehicle width direction allows the responsiveness in the vehicle width direction in the follow-up travel to be lowered.

When the acceleration distribution of the preceding vehicle is equivalent, the travel planning unit 103 selects normal follow-up control regardless of whether the preceding vehicle is a large vehicle or a small vehicle.

It is assumed that the acceleration distribution of the preceding vehicle is longer in the x-axis direction than in the y-axis direction. At this time, the travel planning unit 103 selects the same correction as when the acceleration in the vehicle width direction of the dynamic feature amount of the preceding vehicle in FIG. 7 is large.

As described above, according to the fourth embodiment described above, the preceding vehicle feature amount extraction unit 101 in FIG. 1 can extract the acceleration in the vehicle length direction and the acceleration in the vehicle width direction as the dynamic feature amount of the preceding vehicle, and in the shape of the acceleration plane based on the acceleration in the vehicle length direction and the vehicle width direction of the own vehicle, when the acceleration in the vehicle width direction of the preceding vehicle is larger than the acceleration in the vehicle length direction, and when the vehicle width of the preceding vehicle is smaller than the vehicle width of the own vehicle, the travel planning unit 103 can make corrections of reducing the responsiveness in the vehicle width direction during follow-up travel.

Thus, at the time of following a preceding vehicle with large wobbling, using the static feature amount of the preceding vehicle allows determining how much the wobbling in the vehicle width direction of the preceding vehicle affects the own vehicle, and it is possible to select whether to increase the inter-vehicle distance or to reduce the follow-up gain in the vehicle width direction based on the static feature amount of the preceding vehicle. Thus, it is possible to suppress the wobbling when the own vehicle follows the preceding vehicle.

Hereinafter, a modified example in which a feature amount other than the vehicle width, vehicle height, and rear projection area of the preceding vehicle is used as the static feature amount of the preceding vehicle will be described.

The color and size of the license plate can be used to classify whether the preceding vehicle is a large vehicle or a small vehicle. For example, in Japan, the license plate of a light vehicle with a small vehicle width has black letters on a yellow background or yellow letters on a black background. On the other hand, vehicles that are larger than ordinary cars have green letters on a white background or white letters on a green background. Thus, if the color of the license plate is used as the static feature amount of the preceding vehicle, even if the own vehicle approaches the preceding vehicle and the preceding vehicle is in a traveling state of stopping or at an extremely low vehicle speed, where it is difficult for the own vehicle to obtain the vehicle height and vehicle width, the preceding vehicle classification unit 102 in FIG. 1 can classify the size of the vehicle. Therefore, based on the classification result of the preceding vehicle classification unit 102, the travel planning unit 103 can create the travel plan shown in FIG. 4, the travel plan shown in FIG. 7, or the travel plan shown in FIG. 12.

In addition, the driving force source of the preceding vehicle may be used as the static feature amount of the preceding vehicle. A far-infrared camera capable of recognizing the temperature difference as an image can be used as the outside world recognition unit 120 for estimating the driving force source of the preceding vehicle. When the preceding vehicle is mounted with an internal combustion engine, the temperatures of the exhaust pipe and the catalyst are high. Therefore, photographing the preceding vehicle from behind with an infrared camera causes a characteristic temperature distribution to appear in the captured image. On the other hand, when the preceding vehicle is an electric vehicle, the temperature distribution does not occur as much as that of the preceding vehicle mounted with an internal combustion engine, so that the temperature distribution is different from the case where the preceding vehicle is mounted with an internal combustion engine, and this difference can be used.

Alternatively, an imaging device such as a monocular camera or a stereo camera may be used as the outside world recognition unit 120 for estimating the driving force source of the preceding vehicle. At this time, checking the existence of the exhaust pipe of the preceding vehicle with a monocular camera or a stereo camera makes it possible to identify whether or not the preceding vehicle is mounted with an internal combustion engine.

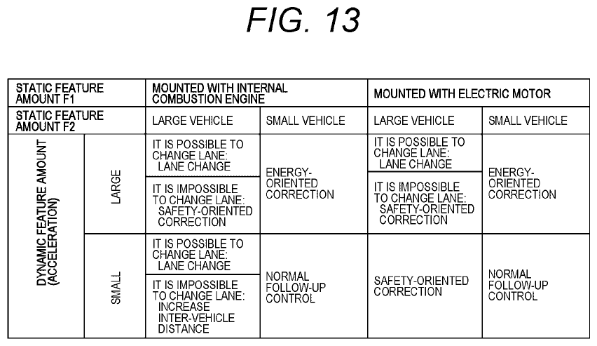

FIG. 13 is a diagram showing an example of a travel plan based on the classification result of the preceding vehicle determined by the travel control device according to the fifth embodiment.

In FIG. 13, the preceding vehicle classification unit 102 in FIG. 1 classifies the preceding vehicle based on the static feature amount F1 in addition to the dynamic feature amount and the static feature amount F2. The dynamic feature amount and the static feature amount F2 are the same as the dynamic feature amount and the static feature amount in FIG. 7. The static feature amount F1 is the driving force source of the preceding vehicle. The driving force source is an internal combustion engine or an electric motor.

When the driving force source is an electric motor, the travel planning unit 103 in FIG. 1 can create a travel plan similar to that in FIG. 7 according to the classification result of the preceding vehicle.

On the other hand, when the driving force source is an internal combustion engine, it is assumed that the static feature amount of the preceding vehicle is a large vehicle, and that the dynamic feature amount of the preceding vehicle is the acceleration in the vehicle length direction classified into small. At this time, when it is impossible to change lanes to the adjacent lane, the travel planning unit 103 increases the target inter-vehicle distance and makes corrections so as to obtain the physical and temporal space for the exhaust gas of the preceding vehicle to diffuse into the atmosphere. On the other hand, when the own vehicle is in travel on a travel route including a plurality of lanes and the lane can be changed to an adjacent lane, the travel planning unit 103 selects the lane change.

Thus, it is possible to prevent the exhaust gas, which is discharged from the large vehicle mounted with an internal combustion engine, from entering the vehicle interior of the own vehicle, and to prevent the loss of comfort during driving.

As described above, according to the fifth embodiment described above, when the preceding vehicle is mounted with an internal combustion engine, and acceleration and deceleration is small so that it takes time to start, it is possible to increase the inter-vehicle distance or to change lanes to the adjacent lane so that the exhaust gas of the preceding vehicle does not enter the vehicle interior of the own vehicle, and it is possible to prevent the exhaust gas of the preceding vehicle from entering the vehicle interior of the own vehicle and impairing comfort.

As the static feature amount of the preceding vehicle, it may be extracted whether the preceding vehicle is a shared bus. At this time, from the display of the destination posted in the back of the preceding vehicle and the detection result that signal lights are not recognized and the preceding vehicle is stopped in front of the bus stop, it is possible to extract that the preceding vehicle is a shared bus as the static feature amount of the preceding vehicle.

Regarding identification of a bus stop, causing the information storage unit 150 in FIG. 1 to store the position of the bus stop as map information, and collating the position of the bus stop with the position of the own vehicle determines that the shared bus is stopped at the bus stop, for example, when the target preceding vehicle is stopped within a distance of 50 m or 25 m from the position of the bus stop. Alternatively, when an imaging device is used as the outside world recognition unit 120, the feature amount such as the shape or color of the bus stop may be detected to identify the bus stop.

When the preceding vehicle is classified as a shared bus, the position information of the own vehicle is compared with the position information of the bus stop, and when the own vehicle is near the bus stop, and planning lane change to the adjacent lane so as to overtake the shared bus being the preceding vehicle or overtaking the preceding vehicle cannot be achieved, similarly to the case of safety-oriented correction, the position of the bus stop is replaced with the position of the light of the traffic light, the height of the bus stop is replaced with the vertical distance from the center line of the route to the bus stop, and the height of the preceding vehicle is replaced with the width of the preceding vehicle, whereby the own vehicle can get closer while keeping a distance from the preceding vehicle heading to the bus stop.

Thus, when a pedestrian jumps out of the blind spot of the bus, it is possible to avoid a scene in which the own vehicle suddenly brakes, and it is possible to improve the ride quality of the own vehicle.

Hereinafter, a modified example in which a feature amount other than the acceleration in the vehicle length direction and the vehicle width direction of the preceding vehicle is used as the dynamic feature amount of the preceding vehicle will be described.

The preceding vehicle feature amount extraction unit 101 in FIG. 1 extracts the travel speed of the preceding vehicle and acquires the speed limit of the traveling route of the preceding vehicle through the communication unit 140 or the information storage unit 150. Then, the preceding vehicle feature amount extraction unit 101 compares the acquisition result of the speed of the preceding vehicle with the speed limit of the traveling route, and calculates the difference as the dynamic feature amount of the preceding vehicle. At this time, when the difference between the speed of the preceding vehicle and the speed limit of the traveling route is negatively large, the preceding vehicle travels at a speed lower than the speed limit, and when the difference between the speed of the preceding vehicle and the speed limit of the traveling route is positively large, the preceding vehicle travels at a speed that exceeds the speed limit.

When a vehicle travels at a speed that exceeds the speed limit, vehicles around such a vehicle are considered to travel at a lower speed than such a vehicle. Therefore, a vehicle traveling at a speed exceeding the speed limit is forced to decelerate when catching up with a low-speed vehicle. That is, a vehicle traveling at a speed exceeding the speed limit is a vehicle violent in acceleration and deceleration, and can be considered to adopt a traveling method unfavorable from the viewpoint of energy consumption. In particular, when the preceding vehicle is a large vehicle, it is difficult for the driver of the own vehicle to recognize a vehicle ahead of the preceding vehicle. Therefore, when a vehicle traveling at a speed exceeding the speed limit catches up with a low-speed vehicle and changes lanes, the low-speed vehicle whose speed is different from that of the preceding vehicle will be the target vehicle that the own vehicle will newly follow. Therefore, it is suitable to keep an inter-vehicle distance to such a target vehicle so that sudden braking is not applied.

That is, the difference between the speed limit of the route and the speed of the preceding vehicle is acquired as the dynamic feature amount of the preceding vehicle. When the preceding vehicle travels beyond the speed limit and when the preceding vehicle is a large vehicle, the inter-vehicle distance is enlarged. Thus, when the preceding vehicle is a large vehicle and it is difficult for the driver to see beyond the preceding vehicle, the inter-vehicle distance is made to increase. Thus, even when the preceding vehicle changes lanes and a low-speed preceding vehicle appears in front of the own vehicle in place of the previous preceding vehicle, it is possible to decelerate while avoiding sudden braking, and it is possible to suppress deterioration in ride quality.

The preceding vehicle feature amount extraction unit 101 in FIG. 1 may extract the inter-vehicle distance between the preceding vehicle and a vehicle further preceding the preceding vehicle as the dynamic feature amount of the preceding vehicle. The preceding vehicle classification unit 102 compares the inter-vehicle distance between the preceding vehicle and the vehicle further preceding the preceding vehicle with the target value of the inter-vehicle distance set when the own vehicle travels at the same speed as the preceding vehicle, whereby the preceding vehicle is classified. When a vehicle follows a preceding vehicle that tends to travel with a short inter-vehicle distance, the vehicle speed of the preceding vehicle tends to fluctuate significantly, and the own vehicle following the preceding vehicle may consume more energy.

Therefore, when the inter-vehicle distance between the preceding vehicle and the vehicle further preceding the preceding vehicle is shorter than the inter-vehicle distance to the preceding vehicle when the own vehicle travels at the speed of the preceding vehicle, the dynamic feature amount of the preceding vehicle is interpreted in the same way as when the acceleration in the vehicle length direction of the preceding vehicle is large.

When radar is used as the outside world recognition unit 120, the inter-vehicle distance between the preceding vehicle and the vehicle further ahead of the preceding vehicle can be acquired with a method of detecting an inter-vehicle distance using the component of the radio wave which has passed under the preceding vehicle, is reflected by the vehicle further ahead of the preceding vehicle, and then is returned. Alternatively, when a vehicle further ahead of the preceding vehicle appears outside the blind spot created by the preceding vehicle on a curve or the like and can be recognized by the own vehicle, the inter-vehicle distance between the preceding vehicle and the vehicle further ahead of the preceding vehicle can be obtained in the same way as the method of obtaining the inter-vehicle distance to the preceding vehicle.

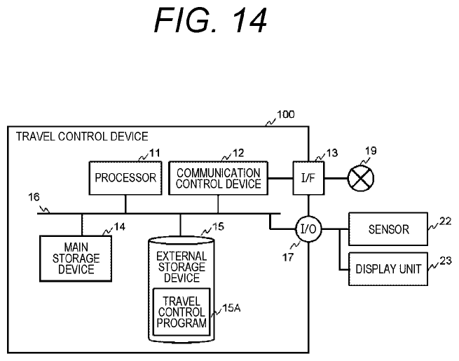

FIG. 14 is a block diagram showing a hardware configuration example of the travel control device in FIG. 1.

In FIG. 14, the travel control device 100 is provided with a processor 11, a communication control device 12, a communication interface 13, a main storage device 14, and an external storage device 15. The processor 11, the communication control device 12, the communication interface 13, the main storage device 14, and the external storage device 15 are connected to each other via the internal bus 16. The main storage device 14 and the external storage device 15 are accessible from the processor 11.

In addition, a sensor 22 and a display unit 23 are provided outside the travel control device 17. The sensor 22 and the display unit 23 are connected to the internal bus 16 via the input and output interface 17. The sensor 22 is, for example, an imaging device, a radar, a sonar, or a laser scanner. The display unit 23 is, for example, a liquid crystal display or an organic EL display.

The processor 11 is hardware that controls the operation of the entire travel control device 17. The main storage device 14 can include, for example, a semiconductor memory such as SRAM or DRAM. The main storage device 14 can store a program being executed by the processor 11 or provide a work area for the processor 11 to execute the program.

The communication control device 12 is hardware having a function of controlling communication with the outside. The communication control device 12 is connected to the network 19 via the communication interface 13. The network 19 is an in-vehicle network such as Control Area Network (CAN), FlexRay, Local Interconnect Network (LIN), and Ethernet (registered trademark).

The input and output interface 17 converts the signal input from the sensor 22 into a data format that can be processed by the processor 11, and converts the data output from the processor 11 into a signal that can be processed by the display unit 23. The input and output interface 17 may be provided with an AD converter and a DA converter.

The external storage device 15 is a storage device having a large storage capacity, and is, for example, a hard disk device or a Solid State Drive (SSD). The external storage device 15 can hold the executable files of various programs. The external storage device 15 can store the travel control program 15A. The travel control program 15A may be software that can be installed in the travel control device 17, or may be incorporated as firmware in the travel control device 17. Reading the travel control program 15A into the main storage device 14 and executing the travel control program 15A, by the processor 11, makes it possible to achieve each function of the preceding vehicle feature amount extraction unit 101, the preceding vehicle classification unit 102, and the travel planning unit 103 in FIG. 1.

The preferred embodiments of the present invention have been described above in detail with reference to the drawings. The drawings do not show the details of its function, configuration, or dimensions, and elements not directly related and those considered to be overlapping functions are omitted or simplified in illustration. Controls and functions not described in an embodiment of the present invention are considered to be achievable by those skilled in the art by means known in the art. The present invention is not necessarily characterized by including all the configurations described above, and is not limited to the configurations of the described embodiments. Part of one embodiment can be replaced with that of another embodiment, and part of the configuration of each embodiment can be added, deleted, or replaced with another configuration unless the characteristics thereof are significantly changed.

### REFERENCE SIGNS LIST

1 self driving system
100 travel control device
101 preceding vehicle feature amount extraction unit
102 preceding vehicle classification unit
103 travel planning unit
110 travel execution unit
111 vehicle dynamics controller
112 drive unit controller
113 steering controller
114 brake controller
120 outside world recognition unit
130 vehicle information acquisition unit
140 communication unit
150 information storage unit
160 human-machine interface
170 to 173 communication network

1. A travel control device comprising:
an extraction unit configured to extract a dynamic feature amount of a preceding vehicle which depends on movement of the preceding vehicle that precedes an own vehicle, and a static feature amount of the preceding vehicle which does not depend on movement of the preceding vehicle;
a classification unit configured to classify the preceding vehicle based on the dynamic feature amount and the static feature amount; and
a planning unit configured to create a travel plan for the own vehicle based on a classification result of the preceding vehicle.

2. The travel control device according to claim 1, wherein the planning unit can select a correction of an inter-vehicle distance or a correction of a time distance, between the own vehicle and the preceding vehicle, based on a classification result of the preceding vehicle.

3. The travel control device according to claim 1, wherein the planning unit can select safety-oriented correction or energy saving-oriented correction with respect to normal follow-up travel based on a classification result of the preceding vehicle.

4. The travel control device according to claim 1, wherein the extraction unit extracts an acceleration in a vehicle length direction of the preceding vehicle as a dynamic feature amount of the preceding vehicle, and extracts at least one of a vehicle width, a vehicle height, and a rear projection area of the preceding vehicle as a static feature amount of the preceding vehicle.

5. The travel control device according to claim 4, wherein when an acceleration at a time of starting of the preceding vehicle is larger than an acceleration at a time of starting of the own vehicle, and a vehicle width or a vehicle height of the preceding vehicle is larger than a predetermined value, the planning unit selects a lane change to an adjacent lane adjacent to a travel lane of the own vehicle.

6. The travel control device according to claim 5, wherein the planning unit determines whether to select the lane change based on a collision margin time or a collision margin with a vehicle traveling in an adjacent lane adjacent to a travel lane of the own vehicle.

7. The travel control device according to claim 4,
wherein the extraction unit extracts an acceleration in a vehicle length direction and an acceleration in a vehicle width direction of the preceding vehicle as a dynamic feature amount of the preceding vehicle, and
wherein in a two-dimensional plane based on an acceleration in a vehicle length direction and a vehicle width direction of the own vehicle, when an acceleration in a vehicle width direction of the preceding vehicle is larger than an acceleration in a vehicle length direction, and a vehicle width of the preceding vehicle is smaller than a vehicle width of the own vehicle, the planning unit selects a correction of reducing responsiveness in a vehicle width direction at a time of following the preceding vehicle.

8. The travel control device according to claim 4, wherein the extraction unit extracts a shape or a color of a license plate of the preceding vehicle as a static feature amount of the preceding vehicle.

9. The travel control device according to claim 4,
wherein the extraction unit extracts whether the preceding vehicle is a shared bus as a static feature amount of the preceding vehicle, and
wherein when the preceding vehicle is classified as a shared bus, based on a comparison result between position information on the own vehicle and position information on a bus stop, the planning unit selects enlargement correction of an inter-vehicle distance between the preceding vehicle and the own vehicle, or lane change.

10. The travel control device according to claim 4,
wherein the extraction unit estimates a driving force source of the preceding vehicle as a static feature amount of the preceding vehicle, and
wherein when the preceding vehicle is mounted with an internal combustion engine, and an acceleration at a time of starting of the preceding vehicle is smaller than an acceleration at a time of starting of the own vehicle, the planning unit selects enlargement correction of an inter-vehicle distance between the preceding vehicle and the own vehicle, or lane change.

11. The travel control device according to claim 4,
wherein the extraction unit extracts a difference between a speed limit of a route on which the preceding vehicle is in travel and a speed of the preceding vehicle as a dynamic feature amount of the preceding vehicle, and
wherein when the preceding vehicle travels beyond the speed limit and a vehicle width or a vehicle height of the preceding vehicle is larger than a predetermined value, the planning unit enlarges an inter-vehicle distance between the preceding vehicle and the own vehicle.

12. The travel control device according to claim 4,
wherein the extraction unit extracts an inter-vehicle distance between the preceding vehicle and a vehicle further preceding the preceding vehicle as a dynamic feature amount of the preceding vehicle, and
wherein when an inter-vehicle distance between the preceding vehicle and a vehicle further preceding the preceding vehicle is shorter than an inter-vehicle distance between the own vehicle and the preceding vehicle when the own vehicle travels at a speed of the preceding vehicle, the planning unit selects energy saving-oriented correction or lane change on normal follow-up travel.

13. A travel control method comprising:
extracting a dynamic feature amount which depends on movement of a second vehicle followed by a first vehicle, and a static feature amount of the second vehicle which does not depend on movement of the second vehicle;
classifying the second vehicle based on the dynamic feature amount and the static feature amount; and
creating a travel plan for the first vehicle based on a classification result of the second vehicle.
